(19) United States
(12) Patent Application Publication
(10) Pub. No.: US 2019/0130342 A1
(43) Pub. Date: May 2, 2019

(54) Managing Operation Of A Package Delivery Robotic Vehicle

(71) Applicant: QUALCOMM Incorporated, San Diego, CA (US)

(72) Inventors: Ankit MAHESHWARI, Hyderabad (IN); Michael Franco TAVEIRA, San Diego, CA (US); Ankur MAHESHWARI, Hyderabad (IN); Shruti AGRAWAL, Hyderabad (IN); Atul SONI, Hyderabad (IN)

(21) Appl. No.: 15/796,989

(22) Filed: Oct. 30, 2017

(51) Int. Cl. G06Q 10/08

(52) U.S. Cl. CPC G06Q 10/083

(57) ABSTRACT

Embodiments include devices and methods for managing operation of a robotic vehicle. A robotic vehicle processor may receive supplemental delivery information from an Internet of Things (IoT) device of a delivery area. The robotic vehicle processor may determine a specific delivery location within the delivery area based on the supplemental delivery information. The robotic vehicle processor may maneuver the robotic vehicle to the specific delivery location to deliver a package at the specific delivery location.

### BACKGROUND

Robotic vehicles (e.g., unmanned aerial vehicles (UAVs) or “drones”) are increasingly used for a wide range of applications. A robotic vehicle may be provided a task or a mission, and may autonomously or semi-autonomously execute one or more aspects of the task or mission. For example, robotic vehicles are being developed for delivering packages to homes and businesses. Currently, a robotic vehicle is provided a delivery destination based on a street address, or a location of a smart phone. However, this information is not sufficient to enable a robotic vehicle to identify exactly where to deliver a package (e.g., at the front door). Some existing implementations require a beacon device or a landing pad with a beacon or target to guide a delivery drone to the specific delivery destination. In such implementations, when a robotic vehicle comes within range of the beacon, the beacon device communicates its location to the robotic vehicle, which can proceed to that location. Such existing implementations require the installation of a beacon device at the delivery destination.

### SUMMARY

Various embodiments include methods of operating a delivery robotic vehicle to deliver a package at a specific delivery location within a delivery area. Various embodiments may include receiving, by a processor of the robotic vehicle, supplemental delivery information from an Internet of Things (IoT) device of a delivery area, determining, by the processor, a specific delivery location within the delivery area based on the supplemental delivery information, and maneuvering the robotic vehicle to deliver a package at the specific delivery location.

Some embodiments may further include the processor determining offset information from the supplemental delivery information, in which determining the specific delivery location within the delivery area may include determining the specific delivery location within the delivery area based on the offset information.

In some embodiments, the offset information may include a distance away from a location of the IoT device. In some embodiments, the offset information may include a coordinate location relative to the IoT device.

Some embodiments may further include the processor receiving location feedback from the IoT device, and determining, by the processor, whether the robotic vehicle is at the specific delivery location based on the location feedback from the IoT device. Some embodiments in which the IoT device is a camera may further include receiving, by the processor, feedback from the camera that the robotic vehicle is at the specific delivery location, and determining whether the robotic vehicle is at the specific delivery location based on the feedback from the camera. In such embodiments, the camera may indicate that the robotic vehicle is in a field of view of the camera. In some embodiments, the IoT device may include one or more of a smart light bulb, a smart door lock, an IoT security camera, a smart thermostat, a smart electricity meter, and an IoT hub device.

In some embodiments, the supplemental delivery information may include one or more of specific delivery location information, prohibited delivery location information, scheduling information, presence information, device control information, or robotic vehicle operating mode information. In some embodiments, the supplemental delivery information may include prohibited location information indicating one or more locations or areas in the delivery area where the robotic vehicle should not deliver the package. In some embodiments, the supplemental delivery information may include scheduling information relating to operation of one or more IoT devices. In some embodiments, the supplemental delivery information may include robotic vehicle operating mode information that assists the robotic vehicle in reaching the specific delivery location.

Some embodiments may further include the processor determining whether the specific delivery location satisfies an acceptance criterion, releasing a package at the specific delivery location in response to determining that the specific delivery location satisfies the acceptance criterion, and determining, a next specific delivery location in response to determining that the specific delivery location does not satisfy the acceptance criterion.

Some embodiments may further include the processor receiving additional supplemental delivery information, and maneuvering to the next specific delivery location based on the additional supplemental delivery information.

Further embodiments include a delivery robotic vehicle having a processor configured with processor-executable instructions to perform operations of any of the methods summarized above. Further embodiments include a delivery robotic vehicle having means for performing functions of any of the methods summarized above. Further embodiments include a non-transitory processor readable medium on which are stored processor-executable instructions configured to cause a processor of a delivery robotic vehicle to perform operations of any of the methods summarized above.

### BRIEF DESCRIPTION OF THE DRAWINGS

The accompanying drawings, which are incorporated herein and constitute part of this specification, illustrate example embodiments, and together with the general description given above and the detailed description given below, serve to explain the features of various embodiments.

FIG. 1 is a system block diagram of a robotic vehicle operating within a communication system suitable for use with various embodiments.

FIG. 2 is a component block diagram illustrating components of a robotic vehicle suitable for use with embodiments.

FIG. 3 is a component block diagram illustrating a processing device suitable for use with embodiments.

FIG. 4 is a process flow diagram illustrating a method of managing operations of a robotic vehicle according to various embodiments.

FIG. 5 is a process flow diagram illustrating a method of managing operations of a robotic vehicle according to various embodiments.

FIG. 6 is a process flow diagram illustrating a method of managing operations of a robotic vehicle according to various embodiments.

FIG. 7 is a process flow diagram illustrating a method of managing operations of a robotic vehicle according to various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and embodiments are for illustrative purposes, and are not intended to limit the scope of the claims.

Various embodiments provide methods and systems of managing operations of a robotic vehicle to deliver a package to a specific delivery location within a delivery area. In some embodiments, the robotic vehicle may navigate to a delivery area using gross navigation capabilities, such as global positioning system (GPS) navigation. Once in or near the delivery area, the robotic vehicle may receive wireless communications from one or more Internet of Things (IoT) devices at or near the delivery area providing supplemental delivery information. A processor of the robotic vehicle may determine a specific delivery location within the delivery area using the supplemental delivery information. The robotic vehicle may perform terminal navigation to the specific delivery location and, for example, deliver a package to the specific delivery location.

In some embodiments, the supplemental delivery information received from one or more IoT devices may include offset information relative to one or more IoT devices. The robotic vehicle may use the offset information to determine the specific delivery location, which may be a location different from the location of the IoT device(s). For example, a smart door knob may provide location information for a specific delivery location that is in front of and below the level of the door knob (e.g., a door mat). As another example, the delivery robotic vehicle may use signals for terminal navigation from an IoT security camera that views the place where the package is to be delivered so that the package can be delivered at a location where the package can be monitored by the camera after the robotic vehicle departs. Using IoT devices to supplement terminal navigation may enable the robotic vehicle to obtain a very accurate position fix in the delivery area, which is typically needed to leave a package at a specific delivery location.

As used herein, the terms “robotic vehicle” and “drone” refer to one of various types of vehicles including an onboard computing device configured to provide some autonomous or semi-autonomous capabilities. Examples of robotic vehicles include but are not limited to: aerial vehicles, such as unmanned aerial vehicles (UAV); ground vehicles (e.g., an autonomous or semi-autonomous car, a vacuum robot, etc.); water-based vehicles (i.e., vehicles configured for operation on the surface of the water or under water); and/or some combination thereof. In some embodiments, the robotic vehicle may be manned. In other embodiments, the robotic vehicle may be unmanned. In embodiments in which the robotic vehicle is autonomous, the robotic vehicle may include an onboard computing device configured to maneuver and/or navigate the robotic vehicle without remote operating instructions (i.e., autonomously), such as from a human operator (e.g., via a remote computing device). In embodiments in which the robotic vehicle is semi-autonomous, the robotic vehicle may include an onboard computing device configured to receive some information or instructions, such as from a human operator (e.g., via a remote computing device), and autonomously maneuver and/or navigate the robotic vehicle consistent with the received information or instructions. In some implementations, the robotic vehicle may be an aerial vehicle (unmanned or manned), which may be a rotorcraft or winged aircraft. For example, a rotorcraft (also referred to as a multirotor or multicopter) may include a plurality of propulsion units (e.g., rotors/propellers) that provide propulsion and/or lifting forces for the robotic vehicle. Specific non-limiting examples of rotorcraft include tricopters (three rotors), quadcopters (four rotors), hexacopters (six rotors), and octocopters (eight rotors). However, a rotorcraft may include any number of rotors. A robotic vehicle may include a variety of components and/or payloads that may perform a variety of functions. The term “components” when used with respect to a robotic vehicle includes robotic vehicle components and/or robotic vehicle payloads.

Robotic vehicles may be used for delivery of items (referred to herein generally as a “package”) to homes and businesses or to otherwise transport items. In some implementations, a robotic vehicle may be provided with a delivery destination based on a street address or a latitude/longitude coordinate. In some implementations, robotic vehicle may be provided with a location of a specific device, such as a smart phone. While this information may enable the robotic vehicle to navigate to a general location (a “delivery area”), this information is not sufficient to enable the robotic vehicle to identify exactly where to deliver the package within a delivery area. For example, general delivery information may enable a robotic vehicle to locate a house, but robotic vehicle may still be unable to determine where precisely to deliver the package—for example, at the front door, behind a hedge, on a welcome mat at the back door, or another similar precise delivery location. In some configurations, a beacon device, which needs to be pre-installed and/or pre-configured, may be deployed in a delivery area, but beacon devices are typically limited to guiding a robotic vehicle to the location of the beacon device.

Various embodiments include methods and systems configured to implement the methods of managing operations of a robotic vehicle to deliver a package to a specific delivery location within a delivery area by leveraging communications with local IoT devices. Non-limiting examples of common IoT devices with which the robotic vehicle may communicate include a smart door lock, a smart doorbell device, and/or an IoT security camera. In some embodiments, the robotic vehicle may determine the specific delivery location by using a radio frequency (RF) transceiver (for example, a Wi-Fi transceiver) receive or obtain “supplemental delivery information” from one or more IoT devices within the delivery area either directly from the IoT devices or from a network (e.g., Wi-Fi network) to which the one or more IoT devices are connected. For example, one or more IoT devices in or around the delivery area (e.g., within a home) may transmit or broadcast the supplemental delivery information in a wireless (e.g., RF) signal. In some embodiments, the robotic vehicle may transmit wireless signals to query an IoT device for the supplemental delivery information. In some embodiments, the one or more IoT devices may transmit the supplemental delivery information in response to receiving a query from a delivery robotic vehicle.

In various embodiments, the processor of the robotic vehicle may determine a specific delivery location based on received supplemental delivery information. The processor may maneuver the robotic vehicle to the specific delivery location within the delivery area using the robotic vehicle's sensors and maneuvering capabilities. Upon reaching the delivery location specified in the received supplemental delivery information, the robotic vehicle may release the package and depart.

In some embodiments, the robotic vehicle may be configured with or maintain an identification of a particular IoT device with which the robotic vehicle should communicate to obtain the supplemental delivery information. For example, the robotic vehicle may obtain an IoT device identifier (e.g., a machine access control (MAC) address or broadcast identifier) that indicates a specific IoT device in or near the delivery area that will provide the supplemental delivery information to the robotic vehicle. In some embodiments, the IoT device identifier may be provided in advance to the delivery robotic vehicle, such as part of a mission planning package based on a consumer's delivery order. In some embodiments, the IoT device identifier may be stored in the consumer's service account with a retailer or delivery service provider.

The robotic vehicle may use the wireless signals from the one or more IoT devices (or IoT devices' network) in a variety of ways. For example, the robotic vehicle may use the IoT device wireless signals to obtain or determine a more accurate position (i.e., “fix”) at the delivery area, such as more accurate that possible Global Positioning System (GPS) signal information. In some embodiments, the robotic vehicle may use the signal strength of one or more wireless signals from IoT device(s) to estimate a separation distance and use that information to determine a more accurate position at the delivery area. The processor may continue to leverage wireless signals received from IoT devices to obtain an accurate position or fix while maneuvering to the specific delivery location.

Additionally or alternatively, the robotic vehicle may receive supplemental delivery information from one or more IoT devices, which the robotic vehicle may use to determine the specific location in a delivery area at which to deliver its package. The robotic vehicle and the IoT device may communicate the supplemental delivery data directly over a wireless link, or via a local intermediary device such as an IoT hub device or a Wi-Fi router in or near the delivery area. In various embodiments, the additional supplemental delivery information received from IoT devices may include (but is not limited to) one or more of specific delivery location information, prohibited delivery location information, scheduling information, presence information, device control information, robotic vehicle operating mode information, and/or the like.

In some embodiments, the supplemental delivery information may include location information expressed in terms (e.g., direction and distance) relative to one or more transmitting IoT devices. In some embodiments, the supplemental delivery information may be general in nature (e.g., an indication that the robotic vehicle should leave the package at a back door). In some embodiments, the supplemental delivery information may be specific (e.g., to the right of the doormat at the back door). In some embodiments, the supplemental delivery information may be highly specific (e.g., 6 inches from the doormat at the back door and 8 inches from the wall; the ledge of the second story window directly above the front door; and the like). In some embodiments, the offset information may vary depending on the location of the IoT device. For example, the offset information may indicate relatively short distances from a smart doorbell (e.g. 6 inches in front of the doorbell and 3 feet below the doorbell), and may indicate relatively long distances from a smart thermostat (e.g., 20 feet from the thermostat) located within a house.

In some embodiments, the supplemental delivery information may include “offset information” in the form of an offset from a particular IoT device or an object that the delivery robotic vehicle may recognize using an onboard camera to capture images that are processed using recognition algorithms. For example, received offset information may include an offset from (and/or relative to) a particular IoT device's location. In some embodiments, the offset information may be general in nature, such as indicating a specific delivery location within 3 feet of a front door, no more than 5 feet from a back porch, near a smart door lock, and the like. In some embodiments, the offset information may be specific, such as including a specific distance from the IoT device. In some embodiments, the offset may include coordinate information relative to the location of the IoT device, such as specified distances away from the IoT device along one or more axes, such as along an X-axis, a Y-axis, and/or a Z-axis. For example, the offset information may specify a delivery location in terms of X+a, Y+b, and/or Z+c, in which X, Y, and Z represent location coordinates of the IoT device, and a, b, and c each represent a distance along a respective axis.

In some embodiments, the supplemental delivery information may include prohibited location information indicating one or more locations or areas in the delivery area where the robotic vehicle should not deliver the package. For example, the supplemental delivery information may include a location of a sprinkler or its watering range and, for example, an indication that the robotic vehicle should not maneuver to such location and/or should not deliver the package in this location (i.e., to minimize damage to the robotic vehicle and/or the package from water). In some embodiments, an IoT sprinkler control system, each IoT sprinkler, and/or one of the IoT sprinklers on behalf of the other sprinklers may provide the location(s) and watering range(s) of the sprinklers. In some embodiments, the watering range may be included as part of the offset information.

In some embodiments, the supplemental delivery information may include a preferred approach route and/or a prohibited approach route to the specific delivery location. In some embodiments, the preferred approach route and/or the prohibited approach route may be based on the presence or absence of an ongoing activity in the delivery area. For example, the ongoing activity may be a sleeping child, and the preferred approach route may direct the robotic vehicle along a path that reduces noise that may wake the child and a prohibited approach route may direct the robotic vehicle to avoid approaching the location of the child. As another example, the ongoing activity may be an activity that requires the item being delivered by the robotic vehicle (for example, construction supplies for an ongoing construction project, food or drinks for an ongoing party, and the like), and the preferred approach route may direct the robotic vehicle along a path that is more direct or efficient to the ongoing activity. Similarly, the prohibited approach route may direct the robotic vehicle to avoid longer or less direct routes.

As another example, the supplemental delivery information may include a location of a smart garage door opener. For example, the robotic vehicle may receive the location of the smart garage door opener and/or offset information relative to the smart garage door opener so that the robotic vehicle does not land and/or deliver the package in the driveway (i.e., to reduce the possibility of the robotic vehicle or package being run over by an automobile or the like). In some embodiments, the supplemental delivery information and/or offset information may include an area between the garage door opener and the street. In some embodiments, the robotic vehicle may use information about the location of the smart garage door opener to maneuver to and/or deliver the package in a specific delivery location that is outside the area (e.g., adjacent to the prohibited location or area).

In some embodiments, an IoT device may notify a vehicle (such as an autonomous or semi-autonomous car or another similar vehicle) that the package has been delivered in the garage, driveway, or another location where the vehicle could hit the package. This notification may be used by the vehicle, for example, to avoid the package, or to send a message (e.g., to a user) requesting that the package be moved.

In some embodiments, the supplemental delivery information may include scheduling information relating to one or more smart devices and/or associated components of the smart devices (e.g., “dumb” sprinklers controlled by a smart sprinkler system). In some embodiments, the scheduling information may indicate timing of operation or deactivation of one or more IoT devices. For example, a smart sprinkler system (or one or more sprinklers) may provide a schedule of when one or more of the sprinklers may run. In some embodiments, the robotic vehicle may maneuver to and/or deliver the package near one or more sprinklers when the one or more sprinklers is not scheduled to run within some determined time (e.g., 4 hours, 24 hours, etc.) based on such scheduling information.

In some embodiments, the supplemental delivery information may include a presence information of a recipient at the delivery destination. In some embodiments, the robotic vehicle may determine a specific delivery location to maneuver to and/or deliver the package in response to determining, based on the presence information, whether someone is at the delivery address (e.g., whether someone is home). An IoT device may obtain the presence information, for example, based on an input received, or a lack of input received for a period of time, at an IoT device that indicates the presence (or absence) of a recipient. An IoT device may obtain the presence information, for example, based on an operational status of one or more IoT devices. For example, a person may not be present if IoT lightbulbs are off throughout the building, if an IoT security system is active, if smart door locks are locked, and/or if a smart thermostat is set in a nonoperational or idle mode. As another example, a person may be present if IoT lights are on, and IoT security system is deactivated, one or more smart door locks are unlocked, a smart thermostat is set to room temperature, and the like.

In some embodiments, the robotic vehicle may obtain or receive the presence information from, e.g., one or more IoT devices, an intermediary device such as an IoT hub, and/or network device such as a server. In some embodiments, in response to determining that the presence information indicates that someone is home, the robotic vehicle may determine a first specific delivery location, and may maneuver to and/or leave the package at the first specific delivery location (e.g., a front door) of the delivery area. In some embodiments, in response to determining the presence information indicates that someone is not home (or in the absence of the presence information), the robotic vehicle may determine a second specific delivery location, and maneuver to and/or leave the package at the second specific delivery location (e.g., a back door) of the delivery area (i.e., a second delivery location that is different than the first delivery location).

In some embodiments, the supplemental delivery information may include device control information that may enable a processor of the robotic vehicle to activate, deactivate, or otherwise control one or more of the IoT devices and/or associated components of the IoT devices in the delivery area. The robotic vehicle may receive the device control information from one or more IoT devices, an IoT hub device, a network element such as a server, and the like. For example, the device control information may enable a processor of the robotic vehicle to signal a garage door opener in the delivery area to open so as to allow the robotic vehicle to enter the garage and/or deliver the package in the garage. As another example, the control information may enable the processor of the robotic vehicle to deactivate a smart device and/or an associated component, such as one or more devices running sprinklers, to allow the robotic vehicle to maneuver to and/or leave the package at a specific delivery location. In some embodiments, the control information may enable the robotic vehicle to provide a more detailed instruction to an IoT device, for example, to deactivate sprinkler(s) or devices or associated components for some period of time, until manually enabled (e.g., by a user), etc. As another example, the control information may enable the processor of the robotic vehicle to activate a IoT device (or associated component), such as a security camera, and/or change the IoT device's settings. For example, the processor of the robotic vehicle may use the control information to enable a nearby security camera to begin recording (e.g., video, audio, and/or images) the specific delivery location so that the delivery can be recorded and the package monitored after the robotic vehicle departs. The control information may enable the processor of the robotic vehicle to adjust or more parameters of the IoT device, such as a media quality/resolution to be captured, enable night-time media capturing, or other settings.

In some embodiments, the supplemental delivery information may include robotic vehicle operating mode information. The operating mode information may provide the robotic vehicle with information that may assist the robotic vehicle in reaching the specific delivery location. For example, the operating mode information may include an indication that the robotic vehicle should change from a first mode of operation (e.g., an aerial mode) to a second mode of operation (e.g., a land-based mode) to reach a specific delivery location. For example, based on the operating mode information, the robotic vehicle may fly to a driveway, land in front of a garage, switch to a land-based mode, and maneuver on the ground into the garage. As another example, based on the operating mode information, the robotic vehicle may approach a delivery area in the land-based mode, then switch to the aerial mode and fly up to a specific delivery location (e.g., on a higher floor). The robotic vehicle may make similar operating mode adjustments, such as to access a covered patio, porch, or other locations; a location above or below street level; a delivery area accessible via a secure entryway (e.g., a drone-specific entryway high up on a building wall), and the like. The processor of the robotic vehicle may thus use the operating mode information to reach a delivery location that may not be accessible when the robotic vehicle is operating in the first mode (e.g., driving through a gate in a land-based mode, driving under a canopy in a land-based mode, flying up to a roof top or other elevated surface, etc.).

In some embodiments, the second mode of operation may provide other benefits such as reduced noise, decreased waiting time at the delivery destination, reduced energy consumption, etc. In some embodiments, the first mode of operation (or the mode of operation by which the robotic vehicle arrived at or near the delivery area) may have a first setting, such as a noise level, and the second of operation mode may be a second setting, such as a reduced noise level, to minimize disruption at the delivery destination.

In some embodiments, the robotic vehicle may receive location feedback information from one or more IoT devices. For example, a robotic vehicle at or near a specific delivery location may receive information from a security camera viewing the specific delivery location indicating the position of the robotic vehicle with respect to the delivery location. The robotic vehicle may use the location feedback information to determine whether the robotic vehicle is at the specific delivery location. The robotic vehicle may also use received location feedback information to adjust its location. For example, the feedback information received from a security camera may indicate that the robotic vehicle is slightly out of view of security camera. The feedback information received from the security camera may indicate, for example, a direction in which the robotic vehicle should maneuver to arrive at the specific delivery location (e.g., directly in view of the security camera).

In some embodiments, in response to determining that the robotic vehicle is not at the specific delivery location (e.g., based on received location feedback information), the robotic vehicle may maneuver to adjust its location, and then receive additional location feedback information from the IoT device(s). In some embodiments, the robotic vehicle may maneuver and receive location feedback information from IoT device(s) in a loop to facilitate maneuvering to the specific delivery location.

In some embodiments, the robotic vehicle may receive location feedback information from an IoT device that relays, or interprets and transmits, information from a non-IoT device. For example, a smart doorknob or a smart door lock may relay information from a non-IoT security camera. As another example, and IoT hub device may process information from a non-IoT security camera, and the IoT hub device may provide processed or interpreted location feedback information based on the information from the non-IoT device.

In some embodiments, the robotic vehicle may evaluate a specific delivery location using one or more robotic vehicle sensors to determine whether the delivery location satisfies an acceptance criterion. The robotic vehicle may employ a variety of acceptance criteria that enable the robotic vehicle to evaluate aspects of the specific delivery location, such as accessibility, availability, safety, stability, likelihood of damage to the robotic vehicle and/or the package, likelihood of injury to a person or animal, and the like.

As an example, the robotic vehicle may maneuver to a determined specific delivery location, such as a doormat. The robotic vehicle may use an onboard camera to inspect the delivery location to detect whether the location is clear or obstructed, such as by a pet sleeping on the doormat. As another example, the robotic vehicle may determine that a specific delivery location (e.g., the doormat) is directly in front of a door, and therefore the specific delivery location does not satisfy an acceptance criterion because of the risk of injury to a person, e.g., tripping on the package.

In response to determining that the specific delivery location does not satisfy the acceptance criterion, the robotic vehicle may determine a next specific delivery location. In some embodiments, the supplemental delivery information may include one or more specific delivery locations (e.g., a primary delivery location, a secondary delivery location, etc.). In some embodiments, the robotic vehicle may transmit wireless signals to query an IoT device for the next specific delivery location. In some embodiments, the robotic vehicle may obtain from an IoT device and/or send a query to an IoT device for additional supplemental delivery information related to the next specific delivery location. The robotic vehicle may use the additional supplemental delivery information to maneuver to the next specific delivery information.

In some embodiments, the robotic vehicle may obtain, or be provided, the supplemental delivery information and/or the offset information at any phase of a delivery, such as (but not limited to) before departing from a shipping/originating location, during transit to the delivery area, upon reaching the delivery area, or at another time and/or location. In some embodiments, the robotic vehicle processor may receive the supplemental delivery information, the offset information, and/or other information (e.g., the identification of the particular IoT device(s), prohibited location information, scheduling information, presence information, device control information, robotic vehicle operating mode information, etc.) at the same time or at different times. For example, certain information may be more useful if it is received when the robotic vehicle arrives at the delivery area (e.g., presence information), and certain information may not be time sensitive (e.g., prohibited location information).

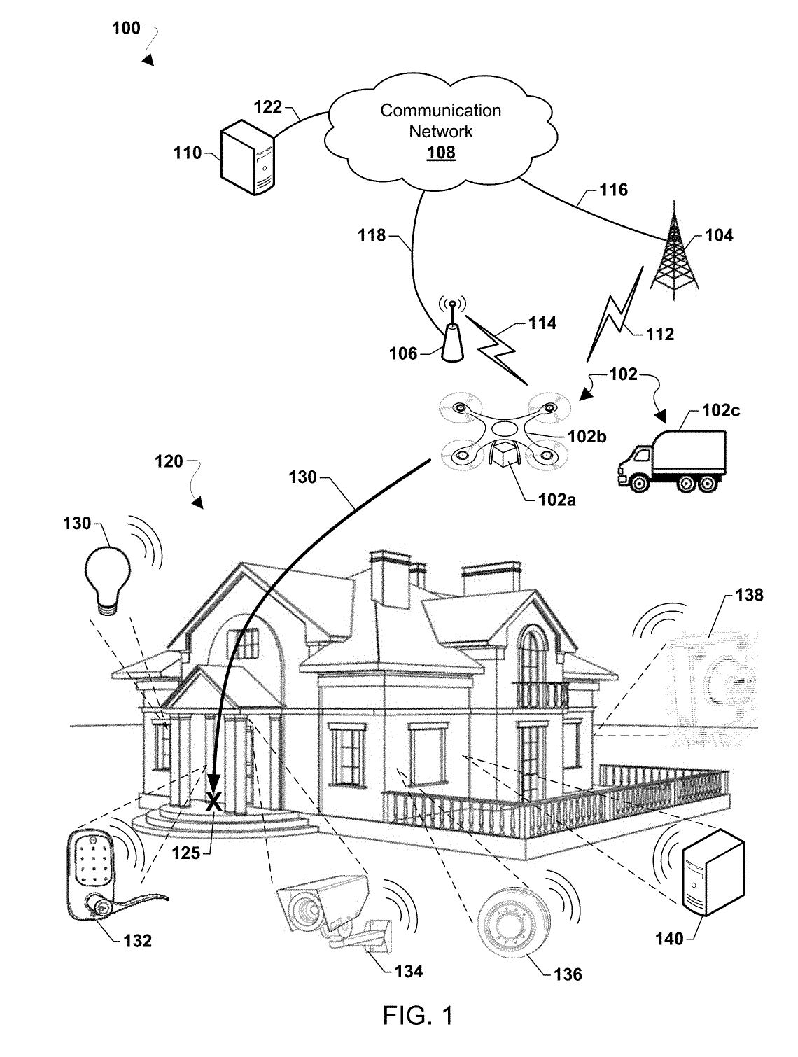

Various embodiments may be implemented within a robotic vehicle operating within a variety of communication systems 100, an example of which is illustrated in FIG. 1. With reference to FIG. 1, the communication system 100 may include a robotic vehicle 102, a base station 104, an access point 106, a communication network 108, and a network element 110.

In some embodiments, the robotic vehicle 102 may be configured to deliver a package 102a. The robotic vehicle 102 may include any form of vehicle, such as an aerial vehicle 102b, a ground vehicle 102c, or another form of vehicle, including any combination thereof (e.g., a vehicle with air and ground maneuvering capabilities).

The base station 104 and the access point 106 may provide wireless communications to access the communication network 108 over a wired and/or wireless communication backhaul 116 and 118, respectively. The base station 104 may include base stations configured to provide wireless communications over a wide area (e.g., macro cells), as well as small cells, which may include a micro cell, a femto cell, a pico cell, and other similar network access points. The access point 106 may be configured to provide wireless communications over a relatively smaller area. Other examples of base stations and access points are also possible.

The robotic vehicle 102 may communicate with the base station 104 over a wireless communication link 112 and with the access point 106 over a wireless communication link 114. The wireless communication links 112 and 114 may include a plurality of carrier signals, frequencies, or frequency bands, each of which may include a plurality of logical channels. The wireless communication links 112 and 114 may utilize one or more radio access technologies (RATs). Examples of RATs that may be used in a wireless communication link include 3GPP Long Term Evolution (LTE), 3G, 4G, 5G, Global System for Mobility (GSM), Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 100 include medium range protocols such as Wi-Fi, LTE-U, LTE-Direct, LAA, MuLTEfire, and relatively short range RATs such as ZigBee, Bluetooth, and Bluetooth Low Energy (LE).

The network element 110 may include a network server or another similar network element. The network element 110 may communicate with the communication network 108 over a communication link 122. The robotic vehicle 102 and the network element 110 may communicate via the communication network 108. The network element 110 may provide the robotic vehicle 102 with a variety of information, such as navigation information, weather information, information about environmental conditions, movement control instructions, and other information, instructions, or commands relevant to operations of the robotic vehicle 102.

In various embodiments, the robotic vehicle 102 may travel to a delivery area 120 along a path of travel 130. The robotic vehicle 120 may maneuver around the delivery area 120 to reach a specific delivery location 125. The delivery area 120 may include one or more IoT devices, such as a smart light bulb or system 130, a smart door lock 132, an IoT security camera 134, a smart thermostat 136, a smart electricity meter 138, and an IoT hub device 140. Each of the IoT devices 130-140 may communicate with each other over wired or wireless communication links. Also, the IoT devices 130-140 and the robotic vehicle 102 may via one or more wireless communication link. In various embodiments, the robotic vehicle 120 may receive wireless signal(s) from the IoT devices 130-140. In some embodiments, the robotic vehicle 120 may receive supplemental delivery information from the IoT devices 130-140. In various embodiments, the robotic vehicle 120 may receive the supplemental delivery information from one or more of the IoT device 130-138 directly via wireless communication link, via the IoT hub device 140, and/or from the network element 110. The robotic vehicle 120 may use the supplemental delivery information to locate and maneuver to the specific delivery location 125, as further described below.

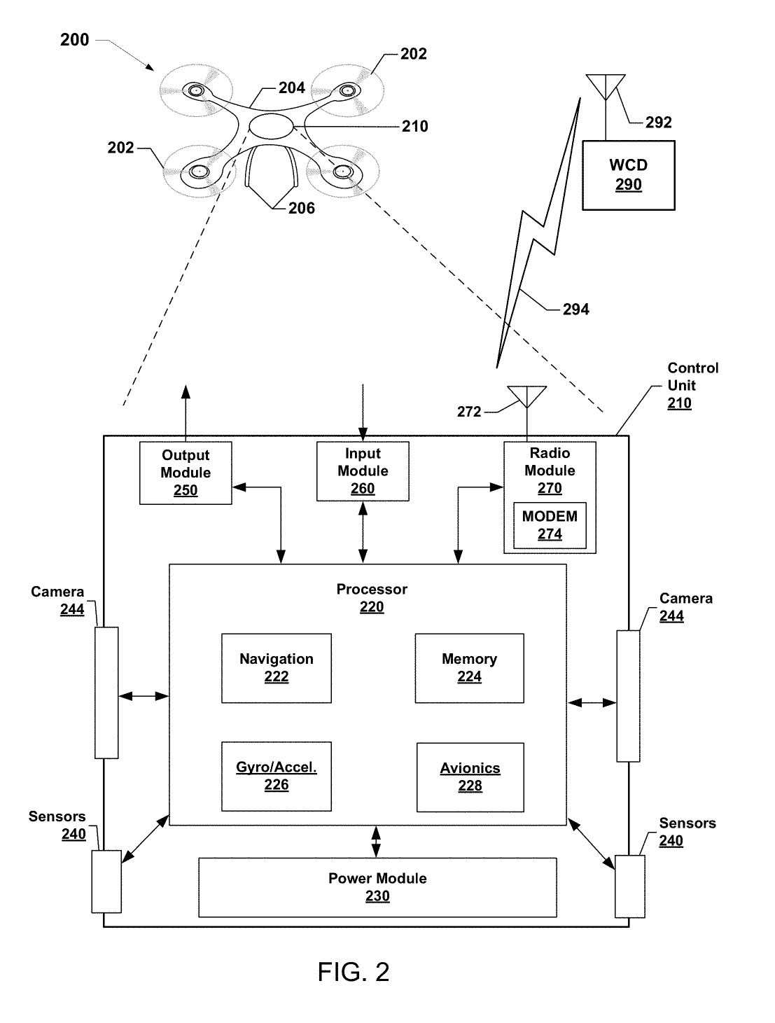

In various embodiments, robotic vehicles may include winged or rotorcraft varieties of aerial robotic vehicles. FIG. 2 illustrates an example of an aerial robotic vehicle 200 that utilizes multiple rotors 202 driven by corresponding motors to provide lift-off (or take-off) as well as other aerial movements (e.g., forward progression, ascension, descending, lateral movements, tilting, rotating, etc.). The robotic vehicle 200 is illustrated as an example of a robotic vehicle that may utilize various embodiments, but is not intended to imply or require that various embodiments are limited to aerial robotic vehicles or rotorcraft robotic vehicles. Various embodiments may be used with winged robotic vehicles, land-based autonomous vehicles, water-borne autonomous vehicles, and space-based autonomous vehicles.

With reference to FIGS. 1 and 2, the robotic vehicle 200 may be similar to the robotic vehicle 102. The robotic vehicle 200 may include a number of rotors 202, a frame 204, and landing columns 206 or skids. The frame 204 may provide structural support for the motors associated with the rotors 202. The landing columns 206 may support the maximum load weight for the combination of the components of the robotic vehicle 200 and, in some cases, a payload. For ease of description and illustration, some detailed aspects of the robotic vehicle 200 are omitted such as wiring, frame structure interconnects, or other features that would be known to one of skill in the art. For example, while the robotic vehicle 200 is shown and described as having a frame 204 having a number of support members or frame structures, the robotic vehicle 200 may be constructed using a molded frame in which support is obtained through the molded structure. While the illustrated robotic vehicle 200 has four rotors 202, this is merely exemplary and various embodiments may include more or fewer than four rotors 202.

The robotic vehicle 200 may further include a control unit 210 that may house various circuits and devices used to power and control the operation of the robotic vehicle 200. The control unit 210 may include a processor 220, a power module 230, sensors 240, one or more cameras 244, an output module 250, an input module 260, and a radio module 270.

The processor 220 may be configured with processor-executable instructions to control travel and other operations of the robotic vehicle 200, including operations of various embodiments. The processor 220 may include or be coupled to a navigation unit 222, a memory 224, a gyro/accelerometer unit 226, and an avionics module 228. The processor 220 and/or the navigation unit 222 may be configured to communicate with a server through a wireless connection (e.g., a cellular data network) to receive data useful in navigation, provide real-time position reports, and assess data.

The avionics module 228 may be coupled to the processor 220 and/or the navigation unit 222, and may be configured to provide travel control-related information such as altitude, attitude, airspeed, heading, and similar information that the navigation unit 222 may use for navigation purposes, such as dead reckoning between Global Navigation Satellite System (GNSS) position updates. The gyro/accelerometer unit 226 may include an accelerometer, a gyroscope, an inertial sensor, or other similar sensors. The avionics module 228 may include or receive data from the gyro/accelerometer unit 226 that provides data regarding the orientation and accelerations of the robotic vehicle 200 that may be used in navigation and positioning calculations, as well as providing data used in various embodiments for processing images.

The processor 220 may further receive additional information from the sensors 240, such as an image sensor or optical sensor (e.g., a sensor capable of sensing visible light, infrared, ultraviolet, and/or other wavelengths of light). The sensors 240 may also include a radio frequency (RF) sensor, a barometer, a humidity sensor, a sonar emitter/detector, a radar emitter/detector, a microphone or another acoustic sensor, a lidar sensor, a time-of-flight (TOF) 3-D camera, or another sensor that may provide information usable by the processor 220 for movement operations, navigation and positioning calculations, and determining environmental conditions. The sensors 240 may also include one or more sensors configured to detect temperatures generated by one or more components of the robotic vehicle, such as thermometers, thermistors, thermocouples, positive temperature coefficient sensors, and other sensor components.

The power module 230 may include one or more batteries that may provide power to various components, including the processor 220, the sensors 240, the one or more cameras 244, the output module 250, the input module 260, and the radio module 270. In addition, the power module 230 may include energy storage components, such as rechargeable batteries. The processor 220 may be configured with processor-executable instructions to control the charging of the power module 230 (i.e., the storage of harvested energy), such as by executing a charging control algorithm using a charge control circuit. Alternatively or additionally, the power module 230 may be configured to manage its own charging. The processor 220 may be coupled to the output module 250, which may output control signals for managing the motors that drive the rotors 202 and other components.

The robotic vehicle 200 may be controlled through control of the individual motors of the rotors 202 as the robotic vehicle 200 progresses toward a destination. The processor 220 may receive data from the navigation unit 222 and use such data in order to determine the present position and orientation of the robotic vehicle 200, as well as the appropriate course towards the destination or intermediate sites. In various embodiments, the navigation unit 222 may include a GNSS receiver system (e.g., one or more global positioning system (GPS) receivers) enabling the robotic vehicle 200 to navigate using GNSS signals. Alternatively or in addition, the navigation unit 222 may be equipped with radio navigation receivers for receiving navigation beacons or other signals from radio nodes, such as navigation beacons (e.g., very high frequency (VHF) omni-directional range (VOR) beacons), Wi-Fi access points, cellular network sites, radio station, remote computing devices, other robotic vehicles, etc.

The radio module 270 may be configured to receive navigation signals, such as signals from aviation navigation facilities, etc., and provide such signals to the processor 220 and/or the navigation unit 222 to assist in robotic vehicle navigation. In various embodiments, the navigation unit 222 may use signals received from recognizable RF emitters (e.g., AM/FM radio stations, Wi-Fi access points, and cellular network base stations) on the ground.

The navigation unit 222 may include a planning application that may perform calculations to plan a path of travel for the robotic vehicle within a volumetric space (“path planning”). In some embodiments, the planning application may perform path planning using information including information about aspects of a task to be performed by the robotic vehicle, information about environmental conditions, an amount of heat that may be generated by one or more components of the robotic vehicle in performing the task, as well as one or more thermal constraints.

The radio module 270 may include a modem 274 and a transmit/receive antenna 272. The radio module 270 may be configured to conduct wireless communications with a variety of wireless communication devices (e.g., a wireless communication device (WCD) 290), examples of which include a wireless telephony base station or cell tower (e.g., the base station 104), a network access point (e.g., the access point 106), a beacon, a smartphone, a tablet, or another computing device with which the robotic vehicle 200 may communicate (such as the network element 110). The processor 220 may establish a bi-directional wireless communication link 294 via the modem 274 and the antenna 272 of the radio module 270 and the wireless communication device 290 via a transmit/receive antenna 292. In some embodiments, the radio module 270 may be configured to support multiple connections with different wireless communication devices using different radio access technologies.

In various embodiments, the wireless communication device 290 may be connected to a server through intermediate access points. In an example, the wireless communication device 290 may be a server of a robotic vehicle operator, a third-party service (e.g., package delivery, billing, etc.), or a site communication access point. The robotic vehicle 200 may communicate with a server through one or more intermediate communication links, such as a wireless telephony network that is coupled to a wide area network (e.g., the Internet) or other communication devices. In some embodiments, the robotic vehicle 200 may include and employ other forms of radio communication, such as mesh connections with other robotic vehicles or connections to other information sources (e.g., balloons or other stations for collecting and/or distributing weather or other data harvesting information).

In various embodiments, the control unit 210 may be equipped with an input module 260, which may be used for a variety of applications. For example, the input module 260 may receive images or data from an onboard camera 244 or sensor, or may receive electronic signals from other components (e.g., a payload).

While various components of the control unit 210 are illustrated as separate components, some or all of the components (e.g., the processor 220, the output module 250, the radio module 270, and other units) may be integrated together in a single device or module, such as a system-on-chip module.

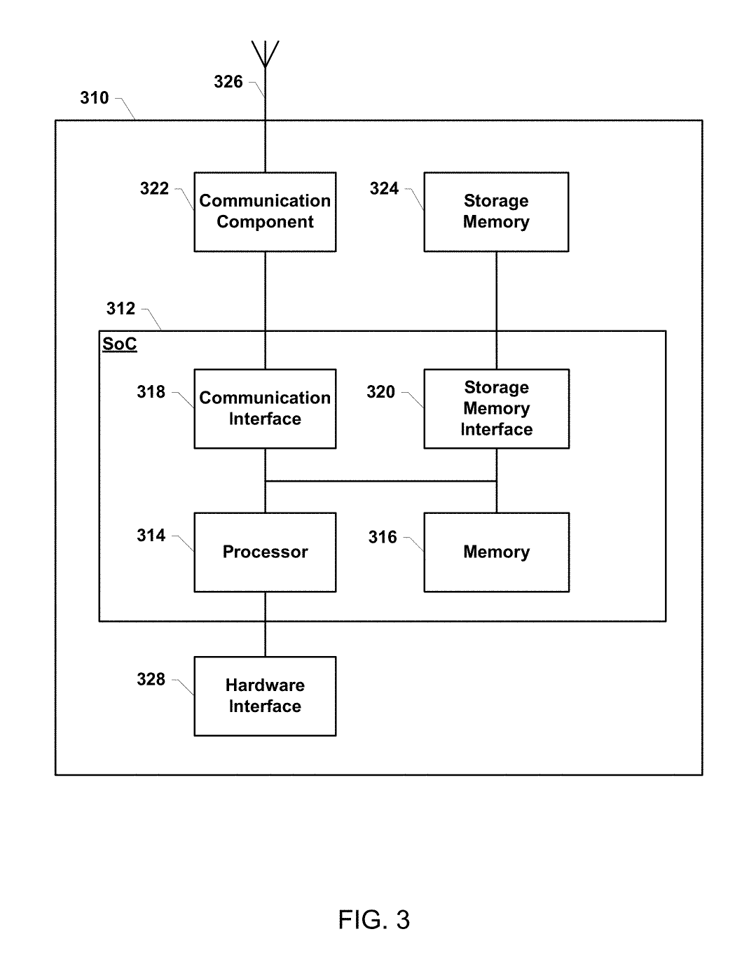

Various embodiments may be implemented within a processing device 310 configured to be used in a robotic vehicle. A processing device may be configured as or including a system-on-chip (SOC) 312, an example of which is illustrated FIG. 3. With reference to FIGS. 1-3, term “system-on-chip” or “SOC” is used herein to refer to a set of interconnected electronic circuits typically, but not exclusively, including one or more processors processor 314, a memory 316, a communication interface 318, and a storage memory interface 320. The processing device 310 or the SOC 312 may further include a communication component 322, such as a wired or wireless modem, a storage memory 324, an antenna 326 for establishing a wireless communication link, and/or the like. The processing device 310 or the SOC 312 may further include a hardware interface 328 configured to enable the processor 314 to communicate with and control various components of a robotic vehicle. The processor 314 may include any of a variety of processing devices, for example any number of processor cores.

An SOC 312 may include a variety of different types of processors 314 and processor cores, such as a general purpose processor, a central processing unit (CPU), a digital signal processor (DSP), a graphics processing unit (GPU), an accelerated processing unit (APU), a subsystem processor of specific components of the processing device, such as an image processor for a camera subsystem or a display processor for a display, an auxiliary processor, a single-core processor, and a multicore processor. The SOC 312 may further embody other hardware and hardware combinations, such as a field programmable gate array (FPGA), an application-specific integrated circuit (ASIC), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

An SOC 312 may include more than one processor 314 and a processing device 310 may include more than one SOC 312, thereby increasing the number of processors 314 and processor cores within the processing device. The processing device 310 may also include other processors (not shown) that are not within an SOC 312 (i.e., external to the SOC 312). Individual processors 314 may be multicore processors. The processors 314 may each be configured for specific purposes that may be the same as or different from other processors 314 of the processing device 310 or SOC 312. One or more of the processors 314 and processor cores of the same or different configurations may be grouped together. A group of processors 314 or processor cores may be referred to as a multi-processor cluster.

The memory 316 of the SOC 312 may be a volatile or non-volatile memory configured for storing data and processor-executable instructions for access by the processor 314. The processing device 310 and/or SOC 312 may include one or more memories 316 configured for various purposes. One or more memories 316 may include volatile memories such as random access memory (RAM) or main memory, or cache memory.

Some or all of the components of the processing device 310 and the SOC 312 may be arranged differently and/or combined while still serving the functions of the various aspects. The processing device 310 and the SOC 312 may not be limited to one of each of the components, and multiple instances of each component may be included in various configurations of the processing device 310.

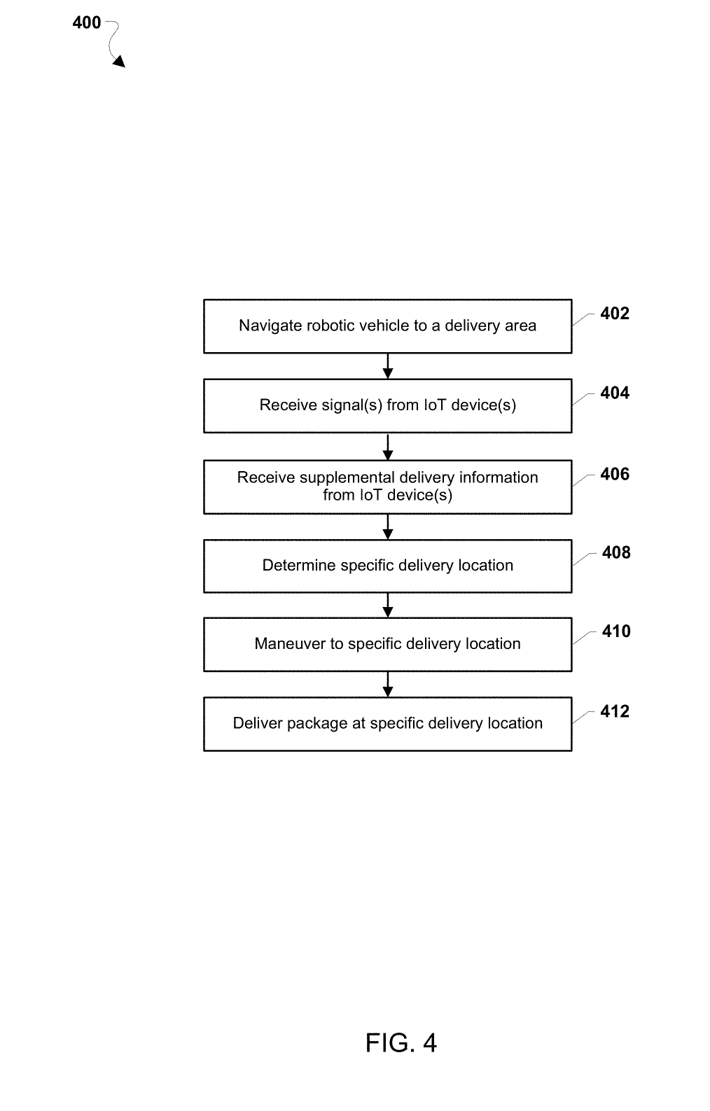

FIG. 4 illustrates a method of managing operations of a robotic vehicle, according to various embodiments. With reference to FIGS. 1-4, the method 400 may be implemented in hardware components and/or software components of the robotic vehicle (e.g., 102, 200), the operation of which may be controlled by one or more processors (e.g., the processor 220, 310, 314 and/or the like) of the robotic vehicle.

In block 402, the processor of the robotic vehicle may navigate the robotic vehicle to a delivery area (e.g., address, coordinates, etc.). In some embodiments, the robotic vehicle may navigate to the delivery area using navigation capabilities such as GPS navigation or another similar navigation capability.

In block 404, the processor of the robotic vehicle may receive one or more signals from one or more IoT devices of the delivery area. In particular embodiments, the processor of the robotic vehicle may determine a position using the one or more signals and one or more signal strengths from the IoT devices. For example, the processor may use the IoT device wireless signals to obtain or determine a more accurate position fix at the delivery area (e.g., compared to a location determinable using GPS signal information). In some embodiments, the processor may use a signal strength of one or more wireless signals from IoT device(s) to determine a more accurate position of the robotic vehicle at the delivery area. In some embodiments, the processor may receive position feedback information from an IoT device, such as an IoT camera imaging the robotic vehicle.

In block 406, the processor of the robotic vehicle may receive supplemental delivery information from the one or more IoT devices of the delivery area. For example, the processor may receive the supplemental delivery information from one or more of the IoT devices 130-140. As another example, the processor may receive the supplemental delivery information from a network element (e.g., the network element 110). In some embodiments, the robotic vehicle may be provisioned with the supplemental delivery information at any point during mission planning, prior to departure, en route, upon arrival at the delivery area, and the like.

In some embodiments, the supplemental delivery information may include prohibited location information indicating one or more locations or areas in the delivery area where the robotic vehicle should not deliver the package. In some embodiments, the supplemental delivery information may include scheduling information relating to one or more smart devices and/or associated components of the smart devices. In some embodiments, the supplemental delivery information may include a presence information of a recipient at the delivery destination. In some embodiments, the supplemental delivery information may include device control information that may enable a processor of the robotic vehicle to activate, deactivate, or otherwise control one or more of IoT devices and/or associated components of the IoT devices in the delivery area. In some embodiments, the supplemental delivery information may include robotic vehicle operating mode information.

In block 408, the processor of the robotic vehicle may determine a specific delivery location (e.g., within the delivery area) based upon the received the supplemental delivery information. In some embodiments, the supplemental delivery information may be general in nature (for example, an indication that the robotic vehicle should leave the package at a back door). In some embodiments, the supplemental delivery information may be specific in nature (for example, to the right of the doormat at the back door). In some embodiments, the supplemental delivery information may be offset information that is highly specific. For example, the offset information may indicate relatively short distances from an IoT device or another landmark (e.g., 6 inches from the doormat at the back door and 8 inches from the wall; 6 inches in front of the doorbell and 3 feet below the doorbell; on the ledge of the second story window directly above the front door; and the like). As another example, the specific delivery location may be based on offset information that is a relatively long distance from an IoT device (e.g., 20 feet from a smart thermostat located within the house).

In some embodiments, the processor may determine the specific delivery location based on the prohibited location information. For example, the processor may determine a location or area in which the robotic vehicle should not deliver the package. In some embodiments, the processor may determine the specific delivery location based on the scheduling information. For example, the scheduling information may indicate timing of operation or deactivation of one or more IoT devices, and the processor may determine the specific delivery location based on the scheduling information.

In some embodiments, the processor may determine the specific delivery location based on the presence information (e.g., information indicating the presence or absence of a recipient at the delivery destination). In some embodiments, the robotic vehicle may determine a specific delivery location to maneuver to and/or deliver the package in response to determining from the presence information whether someone is at the delivery address (e.g., whether someone is home).

In some embodiments, the processor may determine the specific delivery location based on the device control information. For example, the processor may determine that the supplemental delivery information includes control information for a garage door opener, and based on the particular control information in the supplemental delivery information, the processor may determine that the specific delivery location is inside of the garage.

In block 410, the processor of the robotic vehicle may maneuver the robotic vehicle to the specific delivery location. For example, the processor may use sensors and maneuvering capabilities of the robotic vehicle to maneuver to the specific delivery location. The processor may also use device control information to operate one or more IoT devices and/or associated components.

In block 412, the processor of the robotic vehicle may deliver the package to the specific delivery location. After releasing the package, the robotic vehicle may return to a home base or depot.

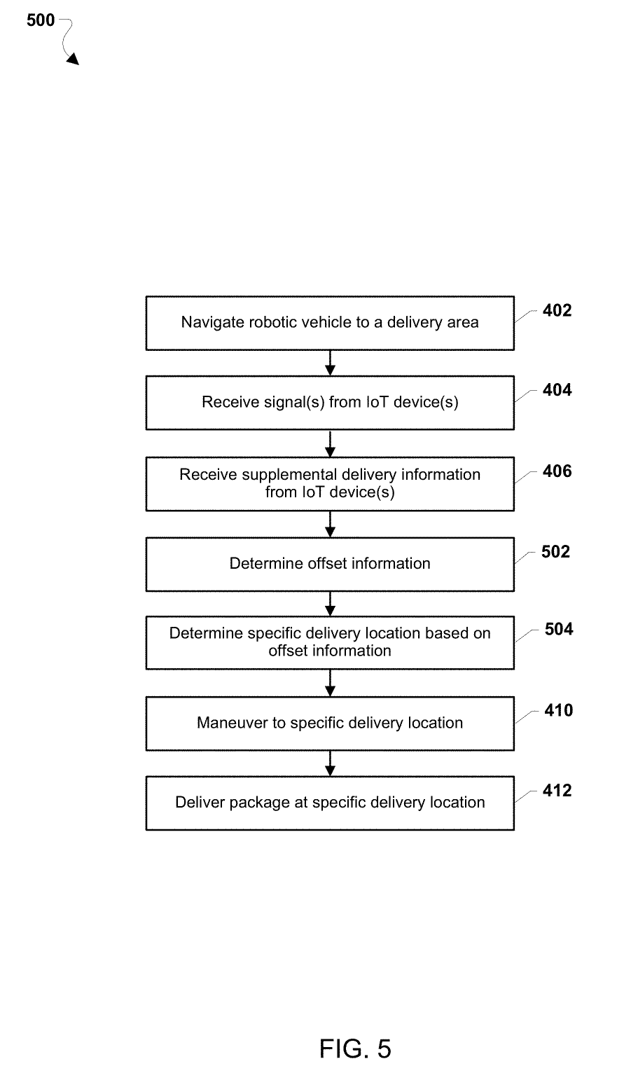

FIG. 5 illustrates a method of managing operation of a robotic vehicle, according to various embodiments. With reference to FIGS. 1-5, the method 500 may be implemented in hardware components and/or software components of the robotic vehicle (e.g., 102, 200), the operation of which may be controlled by one or more processors (e.g., the processor 220, 310, 314 and/or the like) of the robotic vehicle. In blocks 402-412, the device processor may perform operations of like numbered blocks of the method 400.

In block 502, the processor of the robotic vehicle may determine offset information. In some embodiments, the offset information may be included in or provided with the supplemental delivery information. In some embodiments, the offset information may include an offset from (and/or relative to) the IoT device's location.

In some embodiments, the offset information may be general in nature (e.g., indicating a specific delivery location within 3 feet of a front door, no more than 5 feet from a back porch, near a smart door lock, and the like). In some embodiments, the offset information may be specific in nature. For example, the offset may include a distance from the IoT device.

In some embodiments, the offset may include coordinate information, which may be relative to the location of the IoT device. For example, the offset information may indicate a location that is a distance away from the IoT device in one or more dimensions, such as along an X-axis, a Y-axis, and/or a Z-axis (e.g., X+a, Y+b, and/or Z+c, in which X, Y, and Z represent location coordinates of the IoT device, and a, b, and c each represent a distance along a respective axis). The robotic vehicle may then maneuver to the specific delivery location in the delivery area, e.g., using its own sensors and maneuvering capabilities, and may deliver a package to the specific delivery location. In some embodiments, the offset information may vary depending on the location of the IoT device. For example, the offset information may indicate relatively short distances from a smart doorbell, and may indicate relatively long distances from a smart thermostat located within a house.

In block 504, the processor of the robotic vehicle may determine the specific delivery location based on the offset information. For example, the processor may determine the specific delivery location based on general offset information. The processor may use one or more sensors of the robotic vehicle two identify and/or locate the specific delivery location based on the general offset information (e.g., a backdoor, a general distance from a front door, near an object or device, and the like). As another example, the processor may determine the specific delivery location based on more specific offset information, such as a distance away from an IoT device in one or more dimensions.

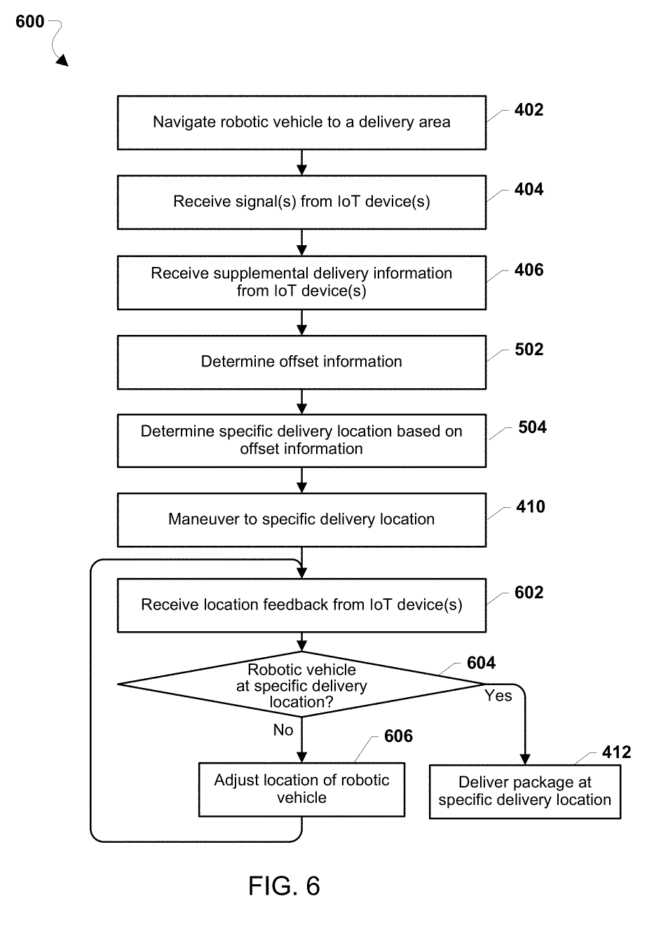

FIG. 6 illustrates a method of managing operation of a robotic vehicle, according to various embodiments. With reference to FIGS. 1-6, the method 600 may be implemented in hardware components and/or software components of the robotic vehicle (e.g., 102, 200), the operation of which may be controlled by one or more processors (e.g., the processor 220, 310, 314 and/or the like) of the robotic vehicle. In blocks 402-412, 502, and 504, the device processor may perform operations of like numbered blocks of the methods 400 and 500.

In block 602, the processor of the robotic vehicle may receive location feedback information from one or more IoT devices. In some embodiments, the robotic vehicle may use the location feedback information to determine whether the robotic vehicle has arrived at the specific delivery location. For example, the processor may receive feedback from an IoT camera (e.g., a security camera) that is viewing the specific delivery location. In some embodiments, the robotic vehicle may receive feedback from the IoT camera that the robotic vehicle is at the specific delivery location. In some embodiments, the robotic vehicle may receive feedback from the IoT camera indicating that the robotic vehicle is in a field of view of the IoT camera. In some embodiments, the robotic vehicle may receive feedback from the IoT camera that the robotic vehicle is a particular direction and/or distance from the specific delivery location, such that the robotic vehicle may use the feedback from the IoT camera to maneuver to the specific delivery location. As another example, the processor may receive proximity information from a smart door lock, a smart doorknob, or another device at or near the specific delivery location.

In determination block 604, the processor of the robotic vehicle may determine whether the robotic vehicle is at the specific delivery location. In some embodiments, the processor may use the location feedback information received from the one or more IoT devices to supplement the robotic vehicle's own location determination, such as the processor may determine using sensors of the robotic vehicle.

In response to determining that the robotic vehicle is not at the specific delivery location (i.e., determination block 604=“No”), the processor may adjust location of the robotic vehicle in block 606. In some embodiments, the processor may adjust the location of the robotic vehicle based on the location feedback information received from one or more IoT devices. The processor may again receive location feedback information from one or more IoT devices in block 602.

In response to determining that the robotic vehicle is at the specific delivery location (i.e., determination block 604=“Yes”), the processor may release the package at the specific delivery location in block 414.

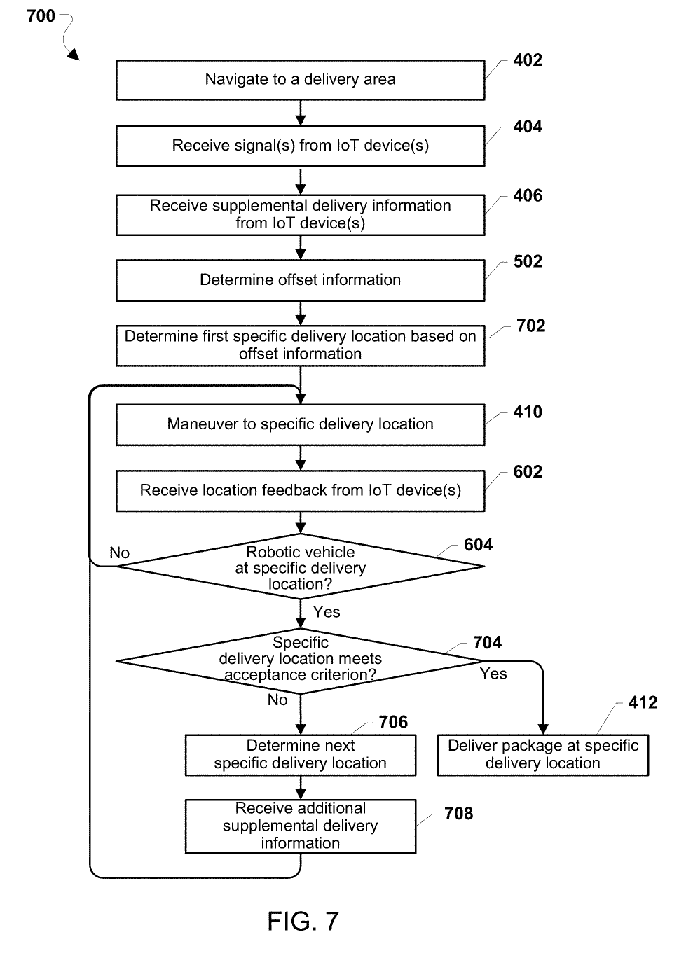

FIG. 7 illustrates a method of managing operation of a robotic vehicle, according to various embodiments. With reference to FIGS. 1-7, the method 700 may be implemented in hardware components and/or software components of the robotic vehicle (e.g., 102, 200), the operation of which may be controlled by one or more processors (e.g., the processor 220, 310, 314 and/or the like) of the robotic vehicle. In blocks 402-412, 502, 602, and 604, the device processor may perform operations of like numbered blocks of the methods 400, 500, and 600.

In some embodiments, the processor of the robotic vehicle may evaluate a specific delivery location (e.g., using one or more robotic vehicle sensors) to determine whether the delivery location satisfies an acceptance criterion. In such embodiments, the processor of the robotic vehicle may select or determine another specific delivery location in response to determining that the first specific delivery location does not satisfy the acceptance criterion. In some embodiments, the supplemental delivery information may include one or more specific delivery locations (e.g., a primary delivery location, a secondary delivery location, etc.). In some embodiments, the robotic vehicle may query an IoT device for the next specific delivery location.

For example, in block 702, the processor of the robotic vehicle may determine a first specific delivery location (based for example, on the supplemental delivery information and/or offset information).

In response to determining that the robotic vehicle is at the specific delivery location (i.e., determination block 604=“Yes”), the processor may determine whether the specific delivery location satisfies an acceptance criterion in determination block 704. For example, the processor may use information from one or more robotic vehicle sensors to determine whether the delivery location satisfies the acceptance criterion. In some embodiments, the robotic vehicle may employ a variety of acceptance criteria that enable the robotic vehicle to evaluate aspects of the specific delivery location, such as accessibility, availability, safety, stability, likelihood of damage to the robotic vehicle and/or the package, likelihood of injury to a person or animal, and the like. For example, the robotic vehicle may detect that a pet is sleeping on the specific delivery location (e.g., doormat), and may determine that specific delivery location does not satisfy an acceptance criterion (e.g., because the pet is in the way). As another example, the robotic vehicle may determine that a specific delivery location (e.g., a windowsill) is directly above a door, and therefore the specific delivery location does not satisfy an acceptance criterion because of the risk of injury to a person (e.g., because the package may fall on someone).

In response to determining that the specific delivery location satisfies the acceptance criterion (i.e., determination block 704=“Yes”), the processor of the robotic vehicle may leave the package at the specific delivery location in block 414.

In response to determining that the specific delivery location does not satisfy the acceptance criterion (i.e., determination block 704=“No), the processor of the robotic vehicle may determine a next specific delivery location in block 706. In some embodiments, the supplemental delivery information may include one or more specific delivery locations (e.g., a primary delivery location, a secondary delivery location, etc.). In some embodiments, the processor may query an IoT device for the next specific delivery location. In some embodiments, the processor may obtain from an IoT device and/or send a query to an IoT device for additional supplemental delivery information related to the next specific delivery location.

In block 708, the processor of the robotic vehicle may receive additional supplemental delivery information related to the next specific delivery location. In various embodiments, the additional supplemental delivery information may include one or more of prohibited location information, scheduling information, presence information, device control information, and robotic vehicle operating mode information. The processor may then maneuver to the next specific delivery location in block 412.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment. For example, one or more of the operations of the methods 400, 500, 600, and 700 may be substituted for or combined with one or more operations of the methods 400, 500, 600, and 700, and vice versa.

The foregoing method descriptions and the process flow diagrams are provided merely as illustrative examples and are not intended to require or imply that the operations of various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an,” or “the” is not to be construed as limiting the element to the singular.

Various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the claims.

The hardware used to implement various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the spirit or scope of the claims. Thus, the present disclosure is not intended to be limited to the embodiments shown herein but is to be accorded the widest scope consistent with the following claims and the principles and novel features disclosed herein.

What is claimed is:

1. A method of managing operations of a robotic vehicle, comprising:
receiving, by a processor of the robotic vehicle, supplemental delivery information from an Internet of Things (IoT) device of a delivery area;
determining, by the processor, a specific delivery location within the delivery area based on the supplemental delivery information; and
maneuvering the robotic vehicle to the specific delivery location to deliver a package at the specific delivery location.

2. The method of claim 1, further comprising:
determining, by the processor, offset information from the supplemental delivery information,
wherein determining the specific delivery location within the delivery area comprises determining the specific delivery location within the delivery area based on the offset information.

3. The method of claim 2, wherein the offset information comprises a distance away from a location of the IoT device.

4. The method of claim 2, wherein the offset information comprises a coordinate location relative to the IoT device.

5. The method of claim 1, further comprising:
receiving, by the processor, location feedback from the IoT device; and
determining, by the processor, whether the robotic vehicle is at the specific delivery location based on the location feedback from the IoT device.

6. The method of claim 1, wherein the IoT device is a camera, the method further comprising:
receiving, by the processor, feedback from the camera that the robotic vehicle is at the specific delivery location; and
determining, by the processor, whether the robotic vehicle is at the specific delivery location based on the feedback from the camera.

7. The method of claim 6, wherein the feedback from the camera indicates that the robotic vehicle is in a field of view of the camera.

8. The method of claim 1, wherein the IoT device comprises one or more of a smart light bulb, a smart door lock, an IoT security camera, a smart thermostat, a smart electricity meter, and an IoT hub device.

9. The method of claim 1, wherein the supplemental delivery information comprises one or more of specific delivery location information, prohibited delivery location information, scheduling information, presence information, device control information, or robotic vehicle operating mode information.

10. The method of claim 1, wherein the supplemental delivery information comprises prohibited location information indicating one or more locations or areas in the delivery area where the robotic vehicle should not deliver the package.

11. The method of claim 1, wherein the supplemental delivery information comprises scheduling information relating to operation of one or more IoT devices.

12. The method of claim 1, wherein the supplemental delivery information comprises presence information of a recipient at the delivery area.

13. The method of claim 1, wherein the supplemental delivery information comprises device control information that enables a processor of the robotic vehicle to control one or more IoT devices.

14. The method of claim 1, wherein the supplemental delivery information comprises robotic vehicle operating mode information that assists the robotic vehicle in reaching the specific delivery location.

15. The method of claim 1, further comprising:
determining, by the processor, whether the specific delivery location satisfies an acceptance criterion;
releasing a package at the specific delivery location in response to determining that the specific delivery location satisfies the acceptance criterion; and
determining, by the processor, a next specific delivery location in response to determining that the specific delivery location does not satisfy the acceptance criterion.

16. The method of claim 15, further comprising:
receiving, by the processor, additional supplemental delivery information; and
maneuvering to the next specific delivery location based on the additional supplemental delivery information.

17. A robotic vehicle, comprising:
a processor configured with processor-executable instructions to:
receive supplemental delivery information from an Internet of Things (IoT) device of a delivery area;
determine a specific delivery location within the delivery area based on the supplemental delivery information; and
maneuver the robotic vehicle to the specific delivery location to deliver a package at the specific delivery location.

18. The robotic vehicle of claim 17, wherein the processor is further configured with processor-executable instructions to:
determine offset information from the supplemental delivery information wherein the offset information comprises a distance away from a location of the IoT device, a coordinate location relative to the IoT device or both; and
determine the specific delivery location within the delivery area based on the offset information.

19. The robotic vehicle of claim 17, wherein the processor is further configured with processor-executable instructions to:
receive location feedback from the IoT device; and
determine whether the robotic vehicle is at the specific delivery location based on the location feedback from the IoT device.

20. The robotic vehicle of claim 17, wherein the IoT device is a camera, and wherein the processor is further configured with processor-executable instructions to:
receive feedback from the camera that the robotic vehicle is at the specific delivery location; and
determine whether the robotic vehicle is at the specific delivery location based on the feedback from the camera.

21. The robotic vehicle of claim 17, wherein the supplemental delivery information comprises device control information that enables the processor to control one or more IoT devices.

22. The robotic vehicle of claim 17, wherein the supplemental delivery information comprises robotic vehicle operating mode information that assists the processor in reaching the specific delivery location.

23. The robotic vehicle of claim 17, wherein the processor is further configured with processor-executable instructions to:
determine whether the specific delivery location satisfies an acceptance criterion;
release a package at the specific delivery location in response to determining that the specific delivery location satisfies the acceptance criterion; and
determine a next specific delivery location in response to determining that the specific delivery location does not satisfy the acceptance criterion.

24. The robotic vehicle of claim 23, wherein the processor is further configured with processor-executable instructions to:
receive additional supplemental delivery information; and
maneuver to the next specific delivery location based on the additional supplemental delivery information.

25. A processing device for use in a robotic vehicle, wherein the processing device is configured to:
receive supplemental delivery information from an Internet of Things (IoT) device of a delivery area;
determine a specific delivery location within the delivery area based on the supplemental delivery information; and
maneuver the robotic vehicle to the specific delivery location to deliver a package at the specific delivery location.

26. The processing device of claim 25, wherein the processing device is further configured to:
determine offset information from the supplemental delivery information, wherein the offset information comprises a distance away from a location of the IoT device, a coordinate location relative to the IoT device, or both; and
determine the specific delivery location within the delivery area based on the offset information.

27. The processing device of claim 25, wherein the processing device is further configured to:
receive location feedback from the IoT device; and
determine whether the robotic vehicle is at the specific delivery location based on the location feedback from the IoT device.

28. The processing device of claim 25, wherein the processing device is further configured to:
determine whether the specific delivery location satisfies an acceptance criterion;
release a package at the specific delivery location in response to determining that the specific delivery location satisfies the acceptance criterion; and
determine a next specific delivery location in response to determining that the specific delivery location does not satisfy the acceptance criterion.

29. The processing device of claim 28, wherein the processing device is further configured to:
receive additional supplemental delivery information; and
maneuver to the next specific delivery location based on the additional supplemental delivery information.

30. A robotic vehicle, comprising:
means for receiving supplemental delivery information from an Internet of Things (IoT) device of a delivery area;
means for determining a specific delivery location within the delivery area based on the supplemental delivery information; and
means for maneuvering the robotic vehicle to the specific delivery location to deliver a package at the specific delivery location.
